(19) United States
(12) Patent Application Publication
(10) Pub. No.: US 2008/0028446 A1
(43) Pub. Date: Jan. 31, 2008

(54) SYSTEM AND METHOD OF EFFICIENT E-MAIL LINK EXPIRATION

(75) Inventor: Andre Burgoyne, Berkeley, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: MYPOINTS.COM INC., San Francisco, CA (US)

(21) Appl. No.: 11/459,900

(22) Filed: Jul. 25, 2006

(51) Int. Cl. H04L 9/32

(52) U.S. Cl. 726/6

(57) ABSTRACT

A method for providing secure and efficient link expiration that includes determining an email address for a member that a link is to be sent; generating a link by encrypting the member's email address; determining an expiration date for the link; and applying a scaling factor to the expiration date. The method also includes combining the expiration date with the link; sending an email message to the member's email address, with the email message including the link embedded therein; taking the member to a web site after receiving data corresponding to selection of the embedded link by the member; determining if the link has expired based on the expiration date with the reduced memory requirement; decrypting the link if it is determined that the link has not expired; and determining if the link is valid.

### TECHNICAL FIELD

The following disclosure relates to a system and method for providing efficient e-mail link expiration by ensuring that the link is usable only once and that the link will expire after a given time period.

### BACKGROUND

Users of the World Wide Web distributed computing environment may freely send and retrieve data across long distances and between remote computing devices. The Web, implemented on the Internet, presents users with documents called “web pages” that may contain information as well as “hyperlinks” which allow the users to select and connect to related web sites. The web pages may be stored on remote computing devices, or servers, as hypertext-encoded files. The servers use Hyper Text Transfer Protocol (HTTP), or other protocols to transfer the encoded files to client users. Many users may remotely access the web sites stored on network-connected computing devices from a personal computer (PC) through a browser application running on the PC.

The browser application may act as an interface between user PCs and remote computing devices and may allow the user to view or access data that may reside on any remote computing device connected to the PC through the World Wide Web and browser interface. Typically, the local user PC and the remote computing device may represent a client and a server, respectively. Further, the local user PC or client may access Web data without knowing the source of the data or its physical location and publication of Web data may be accomplished by simply assigning to data a Uniform Resource Locator (URL) that refers to the local file. To a local client, the Web may appear as a single, coherent data delivery and publishing system in which individual differences between other clients or servers may be hidden.

A system may provide web site proprietors with web site user demographics information and is generally described in U.S. application Ser. No. 09/080946, “DEMOGRAPHIC INFORMATION GATHERING AND INCENTIVE AWARD SYSTEM AND METHOD” to Bistriceanu et al., the entire disclosure of which is hereby incorporated by reference. Generally, the system may include users, web site proprietors, and an enterprise system hosting a central web site. The users may register with the central web site and may earn “points” for performing specific on- or off-line tasks in exchange for disclosing their demographic information during registration. The users may then redeem their earned points at participating proprietors for merchandise or services. Generally, the central web site manages the system by performing a number of tasks including: maintaining all user demographic information, tracking user point totals, and awarding points according to specific, proprietor-defined rules.

Traditional online systems frequently encounter members that forget their password. Often, in these instances, the system users or members are required to two contact a member care person to reset their password. This technique is not particularly secure, because someone in member care services with the online system would then know the member's password. Alternatively, the member is provided with a Web form to fill in their e-mail address, wherein an e-mail is then sent to the member with a link embedded therein to reset the member's password. Because e-mail is not secure and there is no widely accepted standard for encrypting e-mail during transmission, the new password may not be secure. Additionally, the link could be re-used by someone who had observed the e-mail as it was being transmitted, or someone could view the e-mail in the member's account at a later time. For example, someone could hack into the member's e-mail account, or a system administrator could obtain access to the e-mail and embedded link if the administrator would have access to the member's account.

Thus solution to this problem is to ensure that the e-mail link can be used only once. A simple approach to accomplish this would be to remember every such link that was used and to check previously used links each time a member clicked on a “forgot password” e-mail link. However, such a table of used values could grow enormously large and would need to be maintained by removing old values. Furthermore, this implementation would be quite slow and inefficient.

### SUMMARY

A method for providing secure and efficient link expiration includes ensuring that the e-mail link is available only for a limited amount of time, so that people other than the member who gained access to the member's e-mail will not be able to abuse access to the member's account. The security is provided by ensuring that the link is usable only once and ensuring that the link will eventually expire, even if it is never used.

Thus, an efficient method for expiring links and ensuring one-time only use includes determining an email address for a member that a link is to be sent; determining an expiration date for the link; applying a scaling factor to the expiration date to reduce the memory requirement for the expiration date; generating the link by combining a key identifier, an encryption of the member's email address and a unique member ID corresponding to the member. The method also includes sending an email message to the member's email address, with the email message including the link embedded therein; taking the member to a web site after receiving data corresponding to selection of the embedded link by the member; determining if the key identifier has expired; decrypting the link if it is determined that the key identifier has not expired; determining if the link has expired based on the expiration date; determining if the link is valid; and recording the transaction in the member's account.

### BRIEF DESCRIPTION OF THE DRAWINGS

FIG. 1 is a diagram of one example of a network and network devices;

FIG. 2 is a diagram of one example of a general computing device that may operate in accordance with the claims;

FIG. 3 is a diagram of one example of an enterprise system including two groups of servers, a web server, and a firewall as connected to the network of FIG. 1;

FIG. 4 is a flowchart describing a method of one example of using the system of FIG. 3 to award points in exchange for demographics information;

FIG. 5 is another diagram of one example of an enterprise system including a load balancer, a plurality of member server groups, and a single administrative server group;

FIG. 6 is another flowchart describing a method of one example of using the systems of FIGS. 5, 7, and 8 to award points in exchange for demographics information;

FIG. 7 is another diagram of one example of an enterprise system including twelve member server groups and a single administrative server group;

FIG. 8 is another diagram of one example of an enterprise system including a plurality of member server groups, a single administrative server groups, and several components and systems that may enhance system function;

FIGS. 9A and 9B illustrate an exemplary flowchart showing several steps utilized in a method for expiring links and ensuring one-time only use;

FIGS. 10A and 10B illustrate another exemplary flowchart showing several steps utilized in a method for expiring links and ensuring one-time only use;

FIGS. 11A and 11B illustrate another exemplary flowchart showing several steps utilized in a method for expiring links, ensuring one-time only use that includes automatically changing a member's password;

FIG. 12 illustrates an exemplary flowchart showing several steps utilized in a method for expiring links and ensuring one-time only use when verifying a new member's account;

FIG. 13 illustrates an exemplary flowchart showing several steps utilized in a method for expiring links and ensuring one-time only use when sending a campaign e-mail to an existing number;

### DETAILED DESCRIPTION

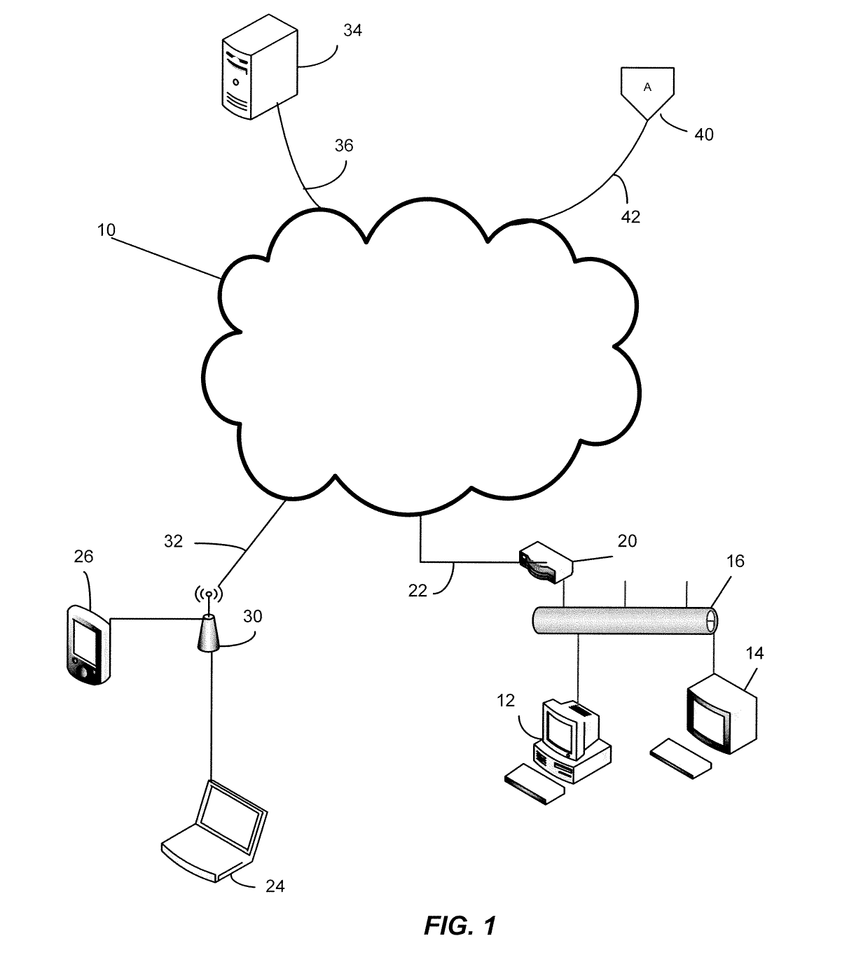

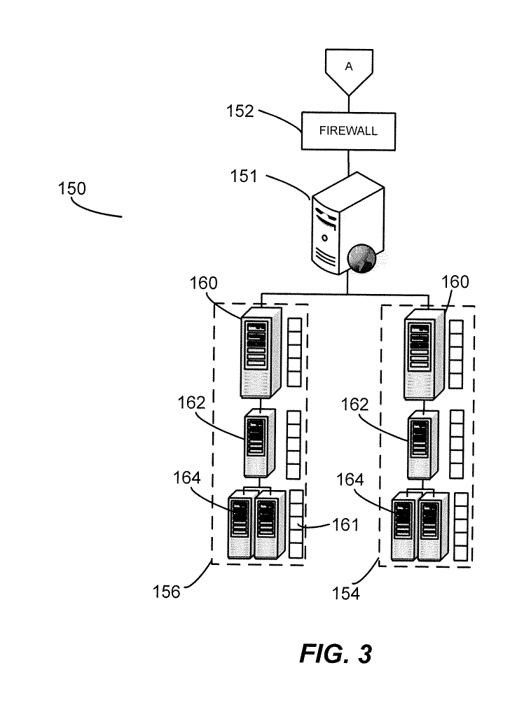

FIG. 1 illustrates an example of a network typical of the World Wide Web. A network 10 may be a virtual private network (VPN), or any other network that allows one or more computers, communication devices, databases, etc., to be communicatively connected to each other. The network 10 may be connected to a PC 12 and a computer terminal 14 via an Ethernet 16 and a router 20, and a land line 22. The network 10 may also be wirelessly connected to a laptop computer 24 and a personal data assistant 26 via a wireless communication station 30 and a wireless link 32. Similarly, a server 34 may be connected to the network 10 using a communication link 36. Also, an enterprise system 40 for awarding points to registered users in exchange for demographic information, as generally illustrated in FIGS. 3, 5, 7, and 8 may be connected to the network 10 using another communication link 42. Where the network 10 includes the Internet, data communication may take place over the network 10 via an Internet communication protocol. In operation, the client PC 12 may view or request data from any other computing device connected to the network 10. Further, the PC 12 may send data to any other computing device connected to the network 10.

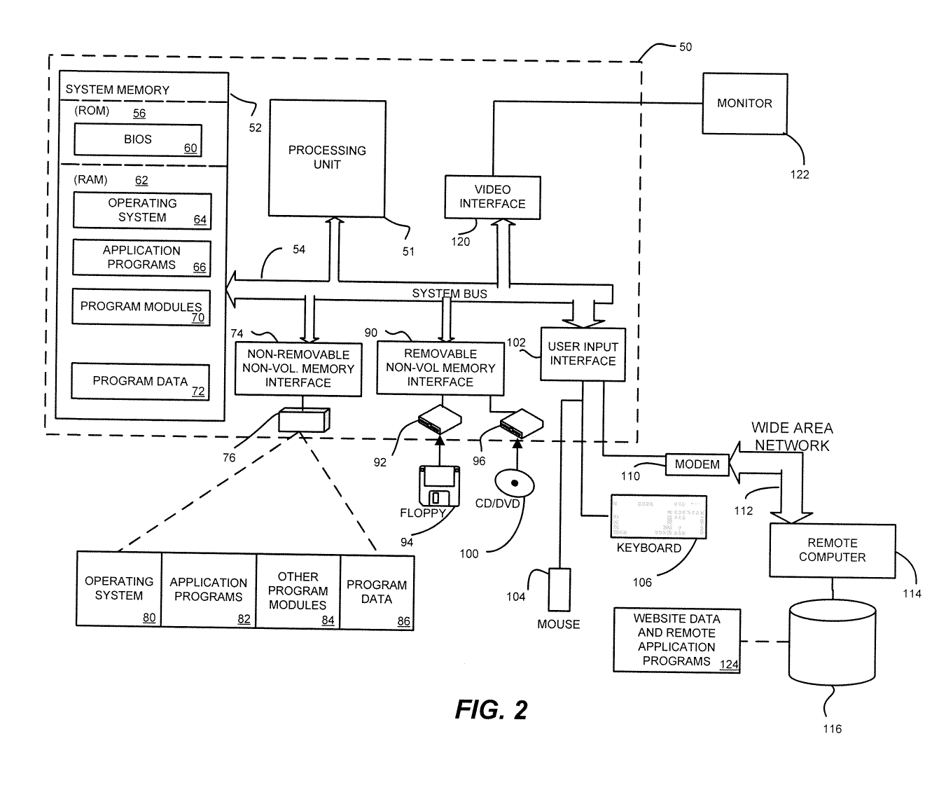

FIG. 2 illustrates a typical computing device 50 that may be connected to the network 10 of FIG. 1 and participate in a distributed computing environment such as the World Wide Web. FIG. 2 may also be an example of an appropriate computing system on which the claimed apparatus and claims may be implemented, however, FIG. 2 is only one example of a suitable computing system and is not intended to limit the scope or function of any claim. The claims are operational with many other general or special purpose computing devices such as PCs 12, server computers 34, portable computing devices such as a laptop 24, consumer electronics 26, mainframe computers, or distributed computing environments that include any of the above or similar systems or devices.

With reference to FIG. 2, a system for implementing the steps of the claimed apparatus may include several general computing devices in the form of a computer 50. The computer 50 may include a processing unit, 51, a system memory, 52, and a system bus 54 that couples various system components including the system memory 52 to the processing unit 51. The system bus 54 may include an Industry Standard Architecture (ISA) bus, a Micro Channel Architecture (MCA) bus, Enhanced ISA (EISA) bus, Video Electronics Standards Association (VESA) local bus, a Peripheral Component Interconnect (PCI) bus or a Mezzanine bus, and the Peripheral Component Interconnect Express (PCI-E) bus.

The computer 50 may include an assortment of computer-readable media. Computer-readable media may be any media that may be accessed by the computer 50. By way of example, and not limitation, the media may include both volatile and nonvolatile media, removable and non-removable media. Media may also include computer storage media and communication media. Computer storage media may include volatile and nonvolatile, removable and non-removable media that stores information such as computer-readable instructions, program modules, data structures, or other data. Computer-storage media may include RAM, ROM, EEPROM, or other memory technology, optical storage disks, magnetic storage devices, and any other medium which may be used to store computer-accessible information. Communication media may be computer-readable instructions, data structures, program modules, or other data in a modulated data signal or other transport mechanism. Communication media may include wired media such as a wired network or direct-wired connection, and wireless media such as RF, infrared, and other wireless media.

The system memory 52 may include storage media in the form of volatile and/or non--volatile memory such as ROM 56 and RAM 62. A basic input/output system 60 (BIOS), containing algorithms to transfer information between components within the computer 50, may be stored in ROM 56. Data or program modules that are immediately accessible or are presently in use by the processing unit 51 may be stored in RAM 62. Data normally stored in RAM while the computer 50 is in operation may include an operating system 64, application programs 66, program modules 70, and program data 72.

The computer 50 may also include other storage media such as a hard disk drive 76 that may read from or write to non-removable, non-volatile magnetic media, a magnetic disk drive 251 that reads from or writes to a removable, non-volatile magnetic disk 94, and an optical disk drive 96 that reads from or writes to a removable, nonvolatile optical disk 100. Other storage media that may be used includes magnetic tape cassettes, flash memory cards, digital versatile disks, digital video tape, solid state RAM, and solid state ROM. The hard disk drive 76 may be connected to the system bus 54 through a non-removable memory interface such as interface 74. A magnetic disk drive 92 and optical disk drive 96 may be connected to the system bus 54 by a removable memory interface, such as interface 90.

The disk drives 92, 96 transfer computer-readable instructions, data structures, program modules, and other data for the computer 50 to different storage media 94, 100 for storage. A hard disk drive 76 may store an operating system 64, application programs 66, other program modules 70, and program data 72. These components may be the same or different from operating system 64, application programs 66, other program modules 70 and program data 72. The components associated with the hard disk drive 76 may be different copies than those associated with RAM 62.

The user may interact with the computer 50 through input devices such as a keyboard 106 or a pointing device 104 (i.e., a mouse). A user input interface 102 may be coupled to the system bus 54 to allow the input devices to communicate with the processing unit 51. A display device such as a monitor 122 may also be connected to the system bus 54 via a video interface 120.

The computer 50 may operate in a networked environment using logical connections to one or more remote computers 114. The remote computer 114 may be a PC 12, a server 34, a router 20, or other common network node as illustrated in FIG. 1. The remote computer 114 typically includes many or all of the previously-described elements regarding the computer 50, even though only a memory storage device 116 is illustrated in FIG. 2. Logical connections between the computer 50 and one or more remote computers 114 may include a wide area network (WAN) 112. A typical WAN is the Internet. When used in a WAN, the computer 50 may include a modem 110 or other means for establishing communications over the WAN. The modem 110 may be connected to the system bus 54 via the user input interface 102, or other mechanism. In a networked environment, program modules depicted relative to the computer 50, may be stored in the remote memory storage device 116. By way of example, and not limitation, FIG. 2 illustrates website data and remote application programs 124 as residing on the memory device 116. As may be appreciated, other means of establishing a communications link between the computer 50 and the remote computer 1140 may be used.

As previously described, the system may award users with redeemable points for many reasons, such as, in exchange for collecting and releasing user demographic information to proprietors or clients and for users taking any action associated with a “campaign,” or set of rules negotiated by the proprietor. As used herein, a user or member may be any person, apparatus, method, or the like that employs a computing device 200 to access the system to earn redeemable points by completing proprietor-defined tasks in exchange for submitting and releasing demographic information to the system.

Further, as used herein, “demographic information” may be broadly construed and may include any kind of member descriptive data, any activity associated with a member, or any transaction associated with a member. Demographic information may be gathered by the system upon user registration in the form of a questionnaire designed to solicit various demographics data of interest to the proprietors. The questionnaire may be in the form of a website page or any other format able to collect demographics information from the user. Users may register in a variety of ways including direct registration at the central web site hosted by the enterprise system, registration through web site proprietors, a web based “refer-a-friend” program, third-party direct mailing, or other partner relationships. A user may need only to register with the system once. However, the user may earn additional points by completing future, supplementary questionnaires. Typical examples of information gathered by the questionnaires may be the user's age, income, occupation, etc. Further, the system may award a user for specific actions such as viewing web-based content, purchasing goods or services through a system-sponsored website, a proprietor's website, a proprietor's brick-and-mortar facility, or any other action associated with the system. The demographics information, to include but not limited to information gathered by questionnaire or records of any user action taken at the suggestion of or related to the system and a proprietor campaign, may be aggregated into a unique user profile. Once the user creates a profile, all future user activity within the system may be uniquely associated with the user's profile. A user may participate in the system by using a network 10 and a PC 12.

Further, as used herein, a proprietor or client may be any entity, corporation, web site manager, business owner, or the like that coordinates with the system by submitting a set of proprietor-defined award rules or tasks that a user may complete to earn redeemable points. The proprietor may also purchase user demographic information from the system and provide product price reductions or other benefits to users in exchange for user demographic information, or may complete any combination of these functions. This set of proprietor-defined rules or tasks may be called a “campaign.” Each campaign may further include a template for e-mails to be sent by the system to targeted users. A proprietor may compensate the system for receiving the users' demographic information in a number of ways including: monthly sponsorship fees for the system displaying their offers on the central web site; per action fees when users follow specific actions provided to the system; per click fees for users clicking on hyperlinks provided in targeted e-mails advertising proprietor services or products and directing the user to a proprietor Web page; per e-mail delivery fees; advertisement placement within “newsletter” e-mails that the system may send to all system-registered users; and other fee combinations including indirect, agency relationships between proprietors and the system. Also, the system may compensate a proprietor for soliciting new memberships. The system may further automate billing clients based on a set billing rules within each campaign. The billing rules may be associated with award rules and user activity. For example, within a particular campaign, an award campaign rule may award a member two hundred points for making a single purchase with a proprietor. The campaign may also include a billing rule indicating that the proprietor may be billed at five percent one all purchases made by the member, even though only the first transaction awarded points. Also, a proprietor may customize its campaign to award a user points in a variety of methods. For example, a proprietor may choose the number of points to be awarded to users, may specify activities or questions that must be completed by the user before points are awarded, or may limit the frequency at which users can be awarded points for visiting the site. A proprietor may also dictate different user questionnaires during the registration process or may provide an additional questionnaire as a user task to be completed by the user to earn additional points.

Also, as used herein, the system may refer generally to the method or apparatus that coordinates user and proprietor functions by collecting user demographic information, awarding redeemable points to the users, tracking points for the users or proprietors, aggregating statistical information concerning user activity and the demographic information, maintaining the proper function of all user and proprietor activity, providing statistical and demographic information to the proprietors, sending targeted e-mail to the users, and executing any other management or coordination functions. The targeted e-mails may contain hyperlinks that direct users to proprietor offers that may award or redeem points to a specific user account. The system may be a collection of devices, typically general purpose computing devices 50, servers, 34, and data stores connected to and in communication with a user PC 12 through a network 10.

A system for collecting demographics information in exchange for awarding redeemable points may include a variety of structures and components as generally described in relation to FIGS. 3, 5, 7, and 8. Therefore, the system configurations described in relation to FIGS. 3, 5, 7, and 8 may include any combination of elements described in relation to each figure.

With reference to FIG. 3, the system 150 may include an architecture that is N-tier with a web server 151 in communication with a system firewall 152 through which a user may access a website hosted on the web server 151 by the system 150. The system firewall 152 may provide a secure, high-speed connection to a computer network such as the Internet as illustrated in FIG. 1. The web server 151 may face the users and communicate with a number of server groups or “silos” such as silo 154 and silo 156. A silo may be a conceptual collection of servers that work together through an application interface. Each silo may include, for example, an application server 160 that may execute a system application program 161.

With reference to FIG. 2 and FIG. 3, a system application program 161 running on the application server 160 may be an application program 66 or a remote application program 124 and may perform any coordination, transformation, or update process on the data entering or exiting the master data server 162. Further, a system application program 161 may execute on any general computing device 50 or any system 150 component. A system application program 161 running on the application server 160 may include, for example, any combination of an e-mail engine, a query engine, a validation engine, a crypto engine, an award engine, or a transaction engine.

Returning to FIG. 3, the application server 160 may communicate between the web server 151 and a master data server 162 to pass data from the web server 151 or to pass data generated by the system application programs 161 to the master data server 162 or any other system 150 element. The master data server 162 may include a portion of the total system 150 data, consisting of, for example, user demographic data, campaign data, and any other data used by the system 150. In turn, the master data server 162 may communicate with replication data servers 164. The replication data servers 164 may include a duplicate copy of the user profile data assigned to the silos 154, 156.

The system capacity is expanded simply by adding more silos 154, 156. The silos 154, 156 may also provide specialized functions within the system 300. For example, the silo 156 may be an administrative silo 156. The administrative silo 156 may be used by the system 150 to manage system information, campaign information, or any other information not related to the user profiles. The administrative silo 156 may also include a lookup table that may direct any data queries to the correct member silo 154. The administrative silo 156 may combine several different functions together, or it may be split apart into separate silos. For example, one administrative silo may contain campaign information while a separate administrative silo may contain a lookup table to direct any data queries to the correct member silo 154. Alternatively, there could be a third administrative silo which manages, for example, inventory information for redemptions. Thus, the administrative functions need not be confined to a single administrative silo. It should be noted that separating some functions into multiple administrative silos may increase the scalability of the system as a whole.

The member silo may hold the system 150 member information. The member information may include, for example, the user profile, demographics data, transactions, or point balances. As illustrated in FIG. 3, a system comprising one member silo 154 may hold approximately 100% of the total system 150 user information. Upon registration, a member's information may be stored in the member silo 154. The silo containing the member's registration data may be called the member's “home silo.” Each member's information may be kept in the member's “home silo,” and may remain in the home silo unless more member silos are added to the system 150.

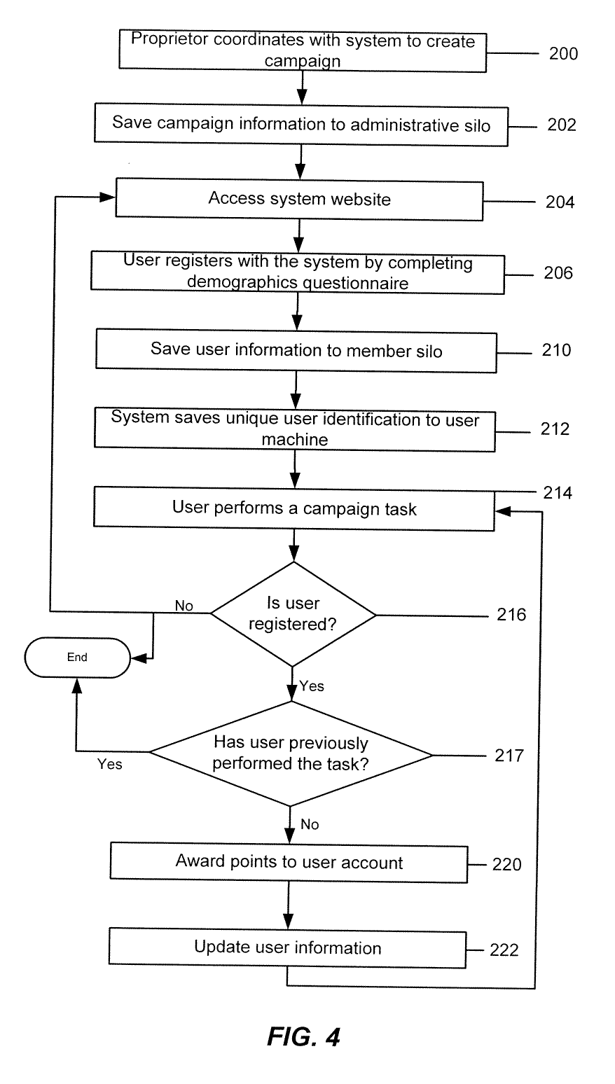

With reference to FIG. 1, FIG. 3, and FIG. 4, a method employing the enterprise system 300 may provide a user with a number of redeemable points for the user's submission of demographic information and participation in a variety of ecommerce related activities, including making purchases from proprietors. The user may then redeem their points for products and services from the participating proprietors such as retailers, theaters, restaurants, airlines, and hotels, among others. At step 200, a proprietor may coordinate with the system 150 to create a campaign For example, the proprietor may request information from the system 150 to target a specific demographic variable such as age, gender, income, or job. At step 202, the campaign information may be distributed to the silos 154, 156 and distributed across all system master data servers 162. At step 204, a user may login to the system 150 using a general purpose personal computer (PC) 12 connected to a network 10 such as the Internet.

As previously described, at step 206, the user may register with the system 150 by accessing a web site hosted by the system 150 at the web server 151. During registration, the user may complete a demographics questionnaire in the form of a web site or other electronic document. The demographics questionnaire may include various questions concerning the user's background including, for example, the user's age, sex, zip code, job title, or marital status. The system, 150 may collect the demographics data in a variety of formats including free form text, drop down menu selections, or Boolean values.

At step 210, the user's registration information and demographic data may be saved to a member silo 154. At step 212, the system may save a unique user identification to the users PC 105. The unique user identification may be used by the system to associate proprietor campaign tasks and user actions to award points. The unique user identification may be encrypted in the form of a “cookie” associated with the user's browser that may be used to associate the user with the registration information stored on the administrative silo 156. Further, the system may assign a 64-bit random number to each user upon registration. Because of the extremely low statistical probability of assigning identical 64-bit random numbers to more than one member upon registration, the system 150 need not verify that the random number has been previously assigned. The random user identification assignment may allow the system 150 to more easily select random user demographic information for analysis. Particularly, because the numbers are randomly assigned, any set of records associated with a sequential selection of the random user identifier may be very unlikely to overlap with any other set chosen by the random number. Further, because the random numbers are only used for choosing a random set of members for statistical analysis, a small number of users with identical random numbers will not distort the results. Therefore, because the probability of the system 150 assigning identical 64-bit random numbers is very small, and a few identical numbers will have very little effect on statistical analysis, it may be unnecessary to ensure that a random number has not been previously assigned.

At step 214, the user may perform any of the tasks or actions specified in the proprietor's campaign stored on the administrative silo 156 to earn redeemable points. For example, a campaign task may be visiting the proprietor's web site or responding to a system 150 generated e-mail.

Each proprietor web site may include a visual cue that the web site is a member of the points-awarding program. The visual cue may include a hyperlink pointing to the web server 151. The hyperlink may include a code called an “cell identification” that may optionally be encrypted and may associate the user's selection of the hyperlink with a campaign task saved on the administrative silo 156. Further, the cell identification may provide information associated with all campaign rules. A user may also receive and select hyperlinks associated with a proprietor's campaign in an e-mail message generated by an e-mail engine running as a system application program 161 on the replication server 164.

The e-mail engine could alternatively be run on the application server 160. However, to increase efficiency, the e-mail engine is run on one or more of the replication servers 164 on each member silo 154. In this way, the e-mail engine communicates locally with the database, avoiding network traffic and also avoiding additional load on the application server 160 which is servicing member requests in real-time. This is possible because the e-mail engine is able to work with a replicated copy of the member information. This provides for a great deal of scalability, as additional replication servers 164 could be added. For example, the replication servers 164 could be increased from two to four so that more than one e-mail engine is running for a given member silo 154.

At step 214, the administrative silo 156 and the application server 160 may validate the user's registration with the award program by comparing the user's cookie file with the registration information stored on the administrative silo 156. The validation process may be performed by a validation engine running as a system application program 161 on the application server 160. If the information received by the application server 315 is encrypted, a crypto engine running as a system application program 161 on the application server 160 may decrypt the information. If the user is not registered, at step 216, the process may terminate or, alternatively, the user may be directed to the system registration web site at step 204. If the user is validly registered, the system 150 may proceed to step 217.

At step 217, the validation engine may determine if the user has previously completed the campaign task associated with step 214. As described above, awarding points may be conditional and defined by the proprietor campaign rules. The campaign tasks and rules may be defined by the proprietor and stored on the administrative silo 156 or distributed across all system 150 silos 154, 156. The tasks and rules may be indexed on the administrative silo 156 by the cell identification. Using the cell identification, the validation engine may determine that a particular cell identification has been previously used, also indicating that the user has previously performed the task and that the user is ineligible for additional points. If the user has previously performed the task, the system 150 may terminate or direct the user to perform a different task. If the user has not yet performed the task, the system may proceed to step 220.

At step 220, if the user is validly registered and has not yet performed the present campaign task, a transaction engine running as a system application program 161 on the application server 160 may award a predetermined number of points to the user's account saved on the member's home silo 154 by associating the campaign task, cell identification, and point quantity with the unique user identification.

At step 222, the transaction engine running as a system application program 161 on the application server 160 may update transaction information associated with the user at the member's home silo 154. Transaction information may later be used by the system 150 to develop demographic information and statistics associated with the user actions to provide to the proprietors. Therefore, upon visiting the proprietor site, the system 150 may automatically award points to the registered user without requiring the user to leave the proprietor web site. The system 150 may be distributed across multiple participating web sites and may operate without the knowledge of the user. Optionally, the proprietor's web sites may determine whether a web site visitor is one of the participating users.

The system 150 may also provide hyperlinks to redemption sites at which the users may convert earned points into products or services. The hyperlinks may be embedded in e-mails generated by the e-mail engine system application program 161. Further, the hyperlinks may point to redemption web sites hosted by the system 150 or on hosts at any other proprietor-designated site. The system 150 may automatically accept redemption orders, place purchase orders with vendors for the requested product or service, and may direct the proprietor or vendor to deliver the redeemed products to the user. The points may be automatically deducted from the user's account.

The system 150 may also develop demographic information and statistics to provide for the proprietors. The system 150 may associate the user demographic information with the users actions associated with the proprietor or any other web site. For example, the percentage of the males visiting a particular web site or web pages may be calculated by looking at each participating visitor in the member silo 154, checking a field in the member silo 154 for each member's sex, and tabulating the results.

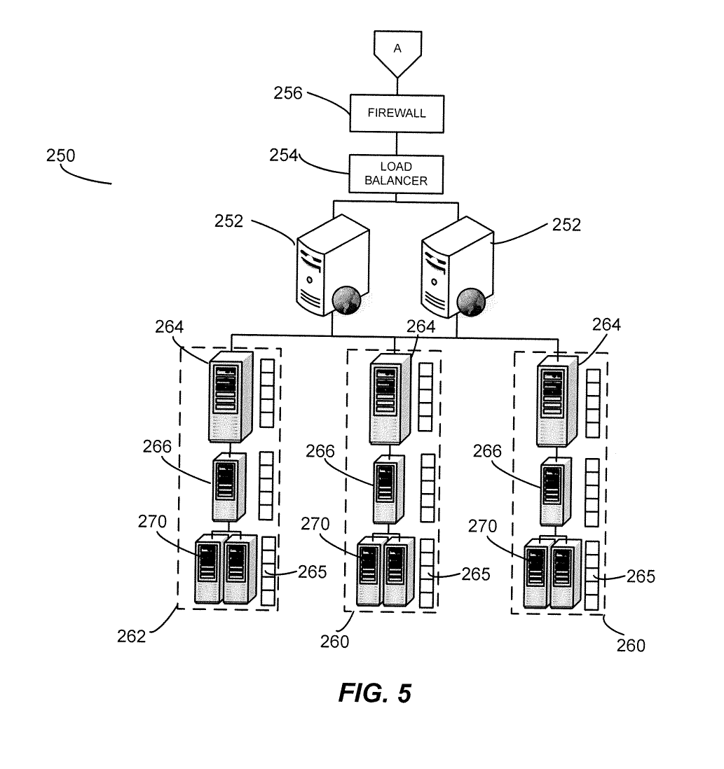

With reference to FIG. 5, the system 250 may include a distributed architecture that is N-tier with web servers 252 that may communicate with a load balancer element 254, wherein the load balancer element 254 communicates with a system firewall 256 and the web servers 252. The load balancer 254 may randomly distribute all data entering the system 250 through the firewall 256 across the web servers 252. The web servers 252 may then determine a silo 260, 262 to send the data. Thus, upon the receipt of data, the load balancer 254 may select a random web server 252, and the randomly-selected web server 252 may forward the data to a specific silo 260, 262, or to a randomly-selected silo 260, 262. The randomly-selected silo 260, 262 may then determine whether to process the data or forward the data to another silo 260, 262. The load balancer's 254 random distribution of data may reduce data latency through the system 250. The load balancer element 254 may include a method executing on a general purpose computer 50 or on any device associated with the system 250 as either software or hardware.

The system firewall 256 may provide a secure, high-speed connection to a computer network such as the Internet as illustrated in FIG. 1. The web server 252 may face the users and communicate with a number of silos 260, 262. A silo may be a conceptual collection of servers that work together through an application interface. Each silo may include, for example, an application server 264 that may execute a system application program 265. A system application program 265 running on the application server 264 may perform any coordination, transformation, or update process on the data entering or exiting the master data server 266. Further, a system application program 265 may execute on any general computing device 50 in communication with the master data server 266. A system application program 161 running on the application server 160 may include, for example, any combination of an e-mail engine, a query engine, a validation engine, a crypto engine, an award engine, or a transaction engine. Each silo may include an application server 264, wherein the application server 264 may communicate between the web server 252 and a master data server 266, and the master data server 266 may communicate with replication data servers 270. The replication data servers 270 may include a duplicate copy of the user profile data assigned to a silo 260, 262.

The silos 260, 262 may provide simple system expandability by providing more silos 260, 262 to the system. The silos 260, 262 may also provide specialized functions within the system 250. For example, the silos 260, 262 may include an administrative silo 262 and member silos 260. The administrative silo 262 may be used by the system 250 to manage system information, campaign information, or any other information that may not relate to the user profiles. The administrative silo 262 may also include a lookup table that may direct any data queries to the correct member silo 260. The member silos 260 may hold an equal or approximately equal fraction of the total amount of user information contained in the system 250 as determined by the load balancer 254. As illustrated in FIG. 5, a system comprising two member silos may each hold approximately 50% of the total system 250 user information. Upon registration, a user's information may be stored on a single, randomly selected member silo 260. The silo containing the user's registration data may be called the user's “home silo.” Each user's information may be kept in the user's “home silo,” and may remain in the home silo unless the member silos 260 are rebalanced. By randomly assigning profiles to the silos, the system load may be balanced and the number of user profiles saved to a single member silo 260 may be no more than any other individual silo 260.

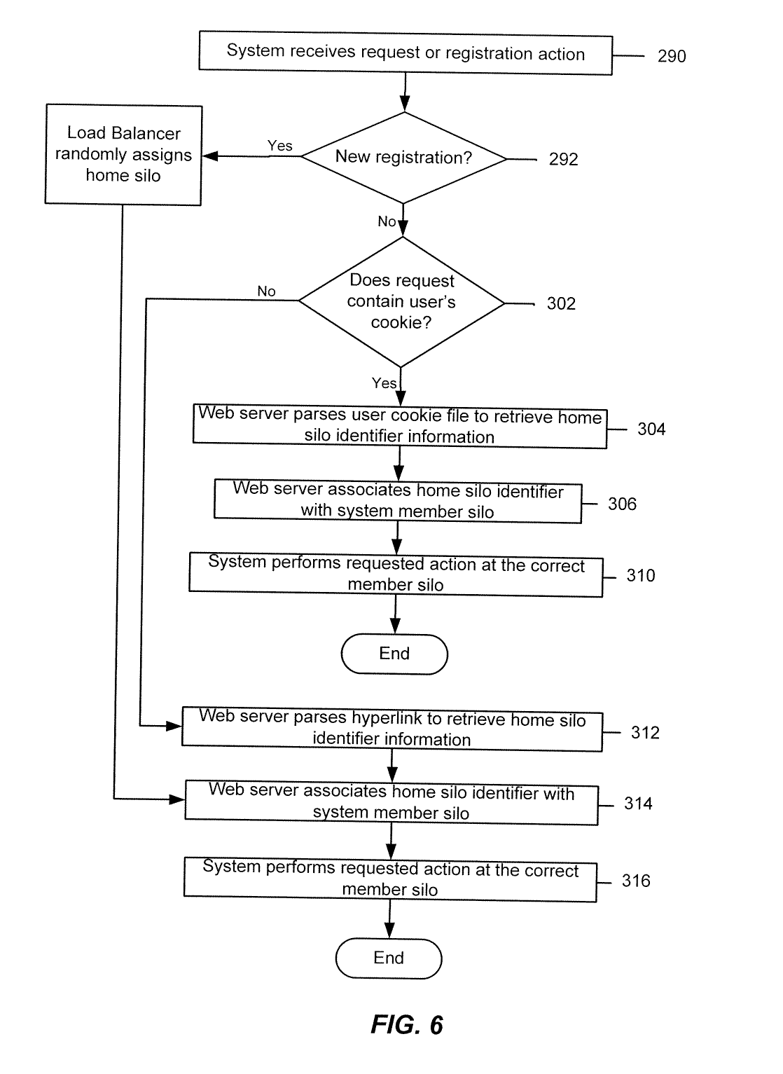

With reference to FIG. 5 and FIG. 6, and as previously described in relation to FIG. 4, the system 250 may need to periodically retrieve or update member silo 260 data to the user's home silo. To correctly identify the user's home silo upon a retrieve or update action, the user's home silo identifier may be persistently stored in several different forms. Particularly, the home silo identifier may be part of a hyperlink in a bulk e-mail sent from the system 250 to the user. Further, the home silo identifier may be part of a URL stored at the user's computer, or may be part of a cookie file. The persistent storage of the user's home silo identifier on the user's computer may also reduce any system 250 overhead associated with finding the user's information. However, once the user is at the system 250, the home silo identifier is not needed to view any successive pages during a single session; the system only requires the home silo identifier upon the first action a user takes at the system 250 during the session. Therefore, the system 250 may acquire user's unique identification number and home silo identifier through encrypted information embedded in a hyperlink included in an e-mail or from any other source. By using the encrypted information, the user may not need to login to the system 250 to complete a transaction. A user may only need to explicitly login to the system 250 when the user visits the central website without going through a hyperlink containing the encrypted identification information and the user's browser does not contain an identifying cookie, or, when the user may perform a “sensitive” action associated with a user's private information or a transaction that may decrease the user's accumulated points.

The system 250 may identify not only the user's home silo but also cached user information through the use of an “application server session.” During an application server 264 session, the system 250 may automatically store a cookie on the user's browser. The cookie may then be used to locate any cached information (including the user's home silo identifier) on successive page views. During an application server session, the cookie may be referred to as a “session cookie.” Thus, while the user is actively at the system 250 and keeping his session with the system 250 open (i.e. does not end the session by closing the browser, deleting all browser cookies, or otherwise ending his session), the system 250 may not need to actively find the user's home silo identification. The system 250 may automatically forward requests to a user's home silo based on the user's application server 264 session. The system may automatically forward the requests using an Apache™ web server 252 with ModJK extensions to a Jetty™ Java™ servlet engine application server 264.

At step 290, the system 250 may receive a user login request, registration request, or update action. If, at step 292, the system 250 receives a new registration, the load balancer 254 may forward the data to a random web server 252 and the web server 252 may assign the registration information a random home silo identifier. By randomly assigning all registrants a home silo identifier, each member silo may contain an approximately equal amount of member information. Further, the data need not retain its home silo identification for its lifetime and may be distributed to other silos 260, 262 as needed for redistribution because no particular data characteristic may tie the data to a silo 260, 262.

After storing the new member information, the system 250 may proceed to step 314. The user request or update action may come from a hyperlink embedded in a targeted e-mail generated by the e-mail engine executing as a system application program 265 on the application server 264. The hyperlink may include the user's home silo identifier information, or alternatively, the action may originate from the user's browser and include the user's cookie file.

If, at step 292, the system 250 receives a non-registration request, the system may, at step 302, determine if the request contains the user's cookie file. At step 304, if the request contains the user's cookie file, the web server 252 may parse the user's cookie file to retrieve the user's home silo identifier information. At step 306, the web server 252 may associate the home silo identifier with a particular system 250 member silo 260. At step 310, the system 250 may perform the requested action at the user's home silo 260. Therefore, the system 250 may perform the action with the user's home silo 260 without performing a lookup or redirect action when the action includes the user's cookie file.

If, at step 302, the request does not contain the user's cookie file, the request likely originated from a system-generated hyperlink that was targeted to a particular user, or the user's browser may not contain the cookie file that correctly associates the user with the user's home silo. The hyperlink therefore may contain the user's home silo identifier 260. At step 312, the web server 252 may then parse the hyperlink to retrieve the user's home silo identifier information. At step 314, the web server may associate the home silo identifier with the correct member silo 260. Therefore, the system 250 may perform the action with the user's home silo 260 without performing a lookup or redirect action when the action originates from a hyperlink containing the user's home silo identifier.

Further, the user's cookie file may contain an inaccurate home silo identifier due to data redistribution or any other reason that may result in the user's data being moved to a location other than a location indicated by the cookie file. If the inaccurate information leads the action to an incorrect silo, the receiving member silo 260 may treat the action as if no browser cookie existed and perform a lookup action to re-direct the data to the correct silo and save a new, accurate, cookie file to the user's browser. Therefore, the system 250 may perform the action with the user's home silo 260 by performing a lookup or redirect action when the action includes an inaccurate cookie file.

Further, if the user's cookie is not set, the system may perform a lookup action by accessing the lookup table residing on the administrative silo 262. Also, if the member's cookie is not set or not present, the load balancer 254 may direct the user to a random member silo 260. A system application program 265 running on the application server 264 may query the master data server 266 or the replication data servers 270 to determine if the action relates to member information stored at that silo 260. If the member data is not stored on the silo 260, the application server 264 may broadcast a request to all silos 260, 262 to find the user's home silo. Once the user's home silo 260 is found, the system 250 generates a re-direct message to the user's browser to re-establish a connection to the system 250 through the web server 252 at the proper home silo 260. The user's browser may then re-establish a connection to the system 250 with a connection message containing the correct home silo 260 identifier. Once the web server 252 receives the re-connect request, user is directed to the proper home silo 260, and the transaction may continue. At step 316, the system 250 may perform the requested action at the correct member silo 260.

As may be appreciated by one of ordinary skill in the art, the system's silo architecture is scalable and inexpensive. Further, the system is robust in that a single silo's malfunction will not degrade the function of the entire system.

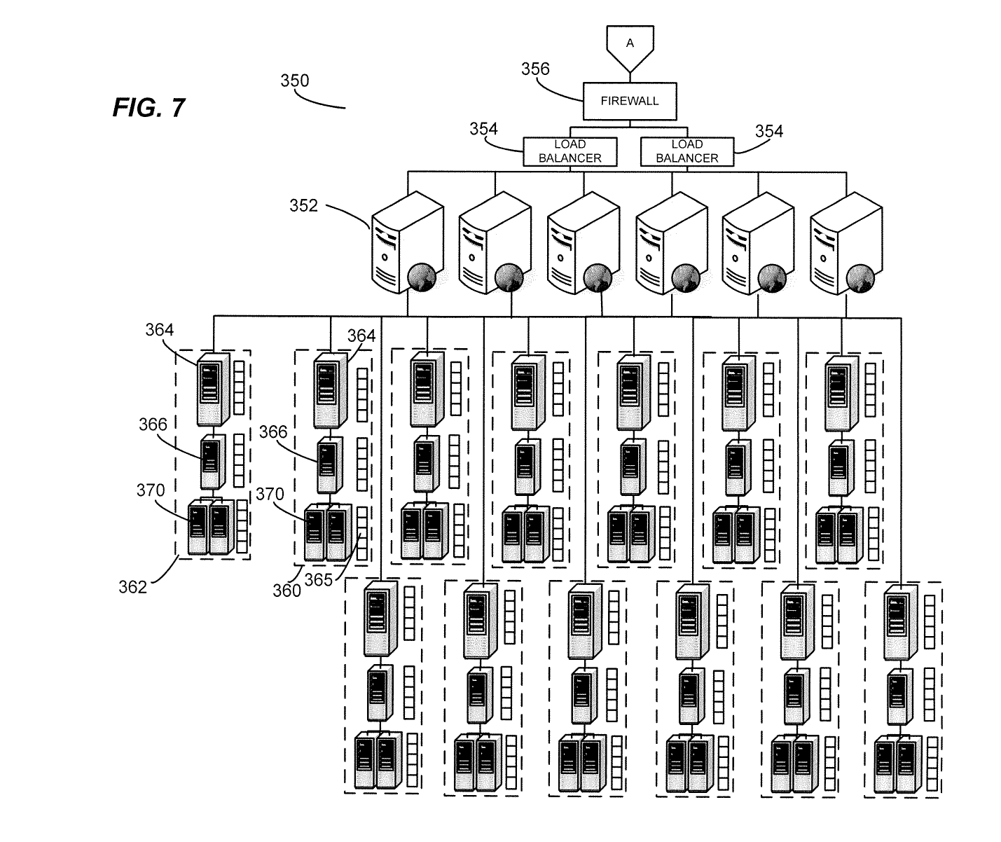

With reference to FIG. 7, the system 350 may also include a distributed architecture that is N-tier with six web servers 352 that may communicate with two load balancer elements 354, wherein the load balancer elements 354 communicate with a system firewall 356 and the web servers 352. The load balancer 354 may randomly distribute all data entering the system 350 through the firewall 356 across the web servers 352. The load balancer's 354 random distribution of data may reduce data latency through the system 350. The load balancer element 354 may include a method executing on a general purpose computer 50 or on any device associated with the system 350 as either software or hardware. The system firewall 356 may provide a secure, high-speed connection to a computer network such as the Internet as illustrated in FIG. 1. The web servers 352 may face the users and communicate with a number of silos 360, 362. A silo may be a conceptual collection of servers that work together through an application interface. Each silo may include an application server 364 executing a system application program 365, wherein the application server 364 may communicate between the web servers 352 and a master data server 366, and the master data server 366 may communicate with replication data servers 370. The master data server 366 and the replication data servers 370 may contain the member profile data to include demographic information, member transaction information, and all member-related data. Member transaction information may include records of every activity in which the member participates including registration information, purchase and activity tracking information, and point-earning information. A system application program 365 running on the application server 364 may perform any coordination, transformation, or update process on the data entering or exiting the master data server 366. Further, a system application program 365 may execute on any general computing device 50 in communication with the master data server 366. A system application program 365 running on the application server 364 may include, for example, any combination of an e-mail engine, a query engine, a validation engine, a crypto engine, an award engine, or a transaction engine. The replication data servers 370 may include a duplicate copy of the user profile data assigned to a silo 360, 362.

The silos 360, 362 may provide simple system expandability by providing more silos 360, 362 to the system. As illustrated in FIG. 7, the system may be expanded to 13 silos 360, 362. The silos 360, 362 may also provide specialized functions within the system 350. For example, the silos 360, 362 may include an administrative silo 362 and twelve member silos 360. The administrative silo 362 may be used by the system 350 to manage system information, campaign information, or any other information that may not relate to the user profiles. The administrative silo 362 may also include a lookup table that may direct any data queries to the correct member silo 360. The member silos 360 may hold an equal or approximately equal fraction of the total amount of user information contained in the system 350 as determined by the load balancer 354 random assignment. As illustrated in FIG. 7, a system comprising twelve member silos may each hold approximately 8% of the total system 350 user information. Upon registration, a user's information may be randomly stored in one member silo 360. The silo containing the user's registration data may be called the user's “home silo.” Each user's information may be kept in the user's “home silo,” and may remain in the home silo unless the member silos 360 may be rebalanced. By randomly assigning profiles to the silos, the system load may be balanced and the number of user profiles saved to a single member silo 360 may be no more than any individual silo 360.

Further, the member silos 360 may have differing storage capacities. The random distribution of data stored on each member silo 360 may then be based on the percentage of system capacity represented by a particular member silo 360 by weighting the preference of the web server 352 to select a home silo 260 upon registration. Thus, a silo 360 having twice the capacity as another silo 360 may be given twice the weighting during random selection. Each user's information may be kept in the user's “home silo,” and may remain in the home silo unless the member silos 360 may be rebalanced. By randomly assigning profiles to the silos, the system load may be balanced and the number of user profiles saved to a single member silo 360 may be no more than any individual silo 360. Also, each silo 360 may poll the system 350 to determine its percentage of system capacity. Instead of random home silo selection, a closed-loop selection mechanism may, for new registrations or anonymous requests, prefer the silo 360 with the least-utilized capacity. Capacity may be measured by any suitable function and may take into account, for example, the amount of disk space available, the system processing load, the I/O capacity, the number of members, or other factors.

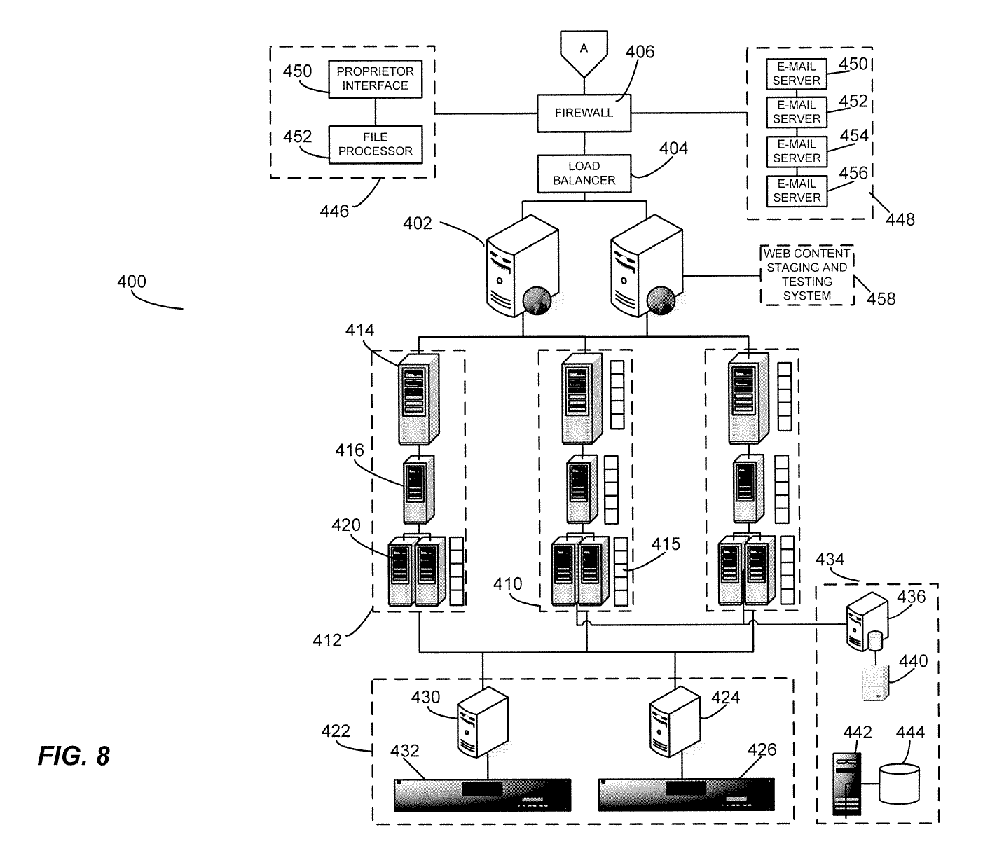

With reference to FIG. 8, the system 400 may also include several components that may complement the awarding of points as previously described. Further, the components may also be added to any of the systems 150, 250, 350 as previously described. As described above, the system 400 may include a distributed architecture that is N-tier with web servers 402 that may communicate with a load balancer element 404, wherein the load balancer element 404 communicates with a system firewall 406 and the web servers 402. The load balancer 404 may randomly distribute all data entering the system 400 through the firewall 406 across the web servers 402. The load balancer's 404 random distribution of data may reduce data latency through the system 400. The load balancer element 404 may include an application executing on a general purpose computer 50 or on any device associated with the system 400 as either software or hardware.

The system firewall 406 may provide a secure, high-speed connection to a computer network such as the Internet as illustrated in FIG. 1. The web server 402 may face the users and communicate with a number of silos 410, 412. A silo 410, 412 may be a conceptual collection of servers that work together through an application interface. Each silo 410, 412 may include an application server 414 executing a system application program 415, wherein the application server 414 may communicate between the web server 402 and a master data server 416, and the master data server 416 may communicate with replication data servers 420. A system application program 415 running on the application server 414 may perform any coordination, transformation, or update process on the data entering or exiting the master data server 416. Further, a system application program 415 may execute on any general computing device 50 in communication with the master data server 416. A system application program 415 running on the application server 414 may include, for example, any combination of an e-mail engine, a query engine, a validation engine, a crypto engine, an award engine, or a transaction engine. The replication data servers 420 may include a duplicate copy of the user profile data assigned to a silo 410, 412.

The silos 410, 412 may provide simple system expandability by providing more silos 410, 412 to the system. The silos 410, 412 may also provide specialized functions within the system 400. For example, the silos 410, 412 may include an administrative silo 412 and member silos 410. The administrative silo 412 may be used by the system 400 to manage system information, campaign information, or any other information that may not relate to the user profiles. The administrative silo 412 may also include a lookup table that may direct any data queries to the correct member silo 410. The member silos 410 may hold an equal or approximately equal fraction of the total amount of user information contained in the system 400 as determined by the load balancer 404. As illustrated in FIG. 8, a system comprising two member silos may each hold approximately 50% of the total system 400 user information. Upon registration, a user's information may be randomly stored in one member silo 410. The silo containing the user's registration data may be called the user's “home silo.” Each user's information may be kept in the user's “home silo,” and may remain in the home silo unless the member silos 410 may be rebalanced. By randomly assigning profiles to the silos 410, 412, the system load may be balanced and the number of user profiles saved to a single member silo 410 may be no more than any individual silo 410. 100711 Further, the silos 410, 412 may collectively communicate with a backup system 422. The backup system 422 may store a duplicate copy of all data stored in the system silos 410, 412. The backup system 422 may include a very high memory capacity server including a primary backup server 424. An example of a very high memory capacity server 424 may be a 2 TB array server. The primary backup server 424 may communicate with a high capacity data cache 426. An example of a high capacity data cache may be a 21 slot, 2-drive LTO2 tape library such as the Exabyte® Ultrium™ family of LTO tape drives. The backup system 422 may further include a secondary backup server 430. The secondary backup server 430 may also be a 2 TB array server. The secondary backup server 430 may also communicate with a secondary high capacity data cache 432. An example of a secondary high capacity data cache may be an LTO3 tape drive such as the Quantum® LTO-3 drive.

The member silo 410 and replication data servers 420 may collectively communicate with a data warehouse system 434. The replication data servers 420 may communicate with a database server 436. The database server 436 may include an extract/transform/load (ETL) server. The database server 436 may communicate with a data warehouse server 440. The data warehouse server 440 may include a 2 TB array. The data warehouse system 434 may also include legacy data related to prior versions of the points-awarding system 400. The legacy data may be stored in a modular workgroup server 442 such as the Sun Microsystems® E420R. The workgroup server 442 may further communicate with one or more data stores 444 containing the legacy data.

A proprietor interface system 446 may also communicate directly with the system 400 through the system firewall 406. The proprietor interface system 446 may allow a proprietor to directly access user data stored on the system silos 410, 412. This access may allow the proprietors to collect demographic and statistical information concerning the user data on the silos 410, 412. The proprietor interface system 446 may include a proprietor interface 450. The proprietor interface 450 may be a secure connection to allow the proprietors to upload or download data to the system 446. The proprietor interface 450 may employ a protocol enabling the secure transmission of web pages such as hypertext transfer protocol over a secure socket layer (https).

The proprietor interface 450 may be in communication with a file processing element 452. The file processing element 452 may allow proprietors to access the system 400 to shop for demographics information or to store and process client information or added demographics questions for use during user registration. Proprietors may also upload member activity which is stored as member transactions in the member's home silo and which may, further, trigger both billable activity transactions and award transactions in association with each particular member and each particular campaign.

An e-mail relay system 448 may also communicate with the system 400 though the firewall 406. The e-mail relay system 448 may include four servers 450, 452, 454, 456 in communication with the system 400. The e-mail relay system 448 may direct incoming e-mails, such as delayed bounces from outgoing bulk mails sent by the system, to the proper components of the system 400.

A web content staging and testing system 458 may also communicate with the system in a variety of methods. For example, the web content staging and testing system 458 may communicate with the system 400 through the web severs 402. The web content staging and testing system 458 may comprise a number of general computing devices 50 that may provide a secure and efficient environment for system 400 administrators to develop a variety of data for the system 400 before the data may be deployed live.

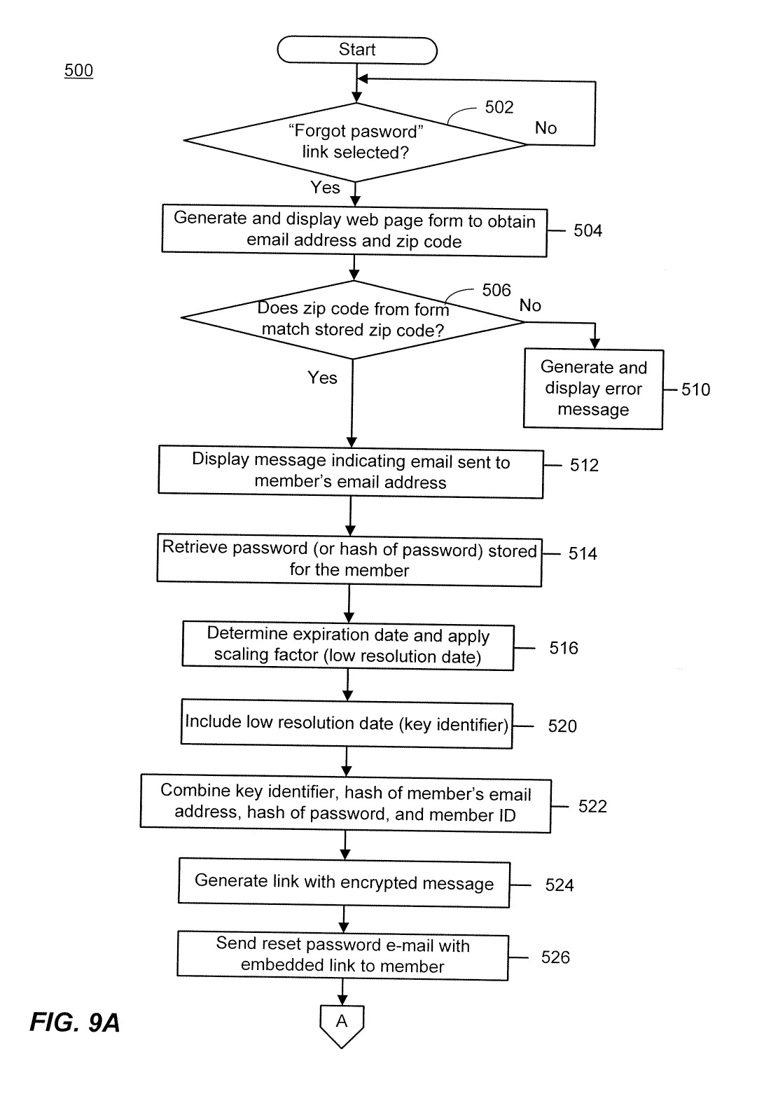

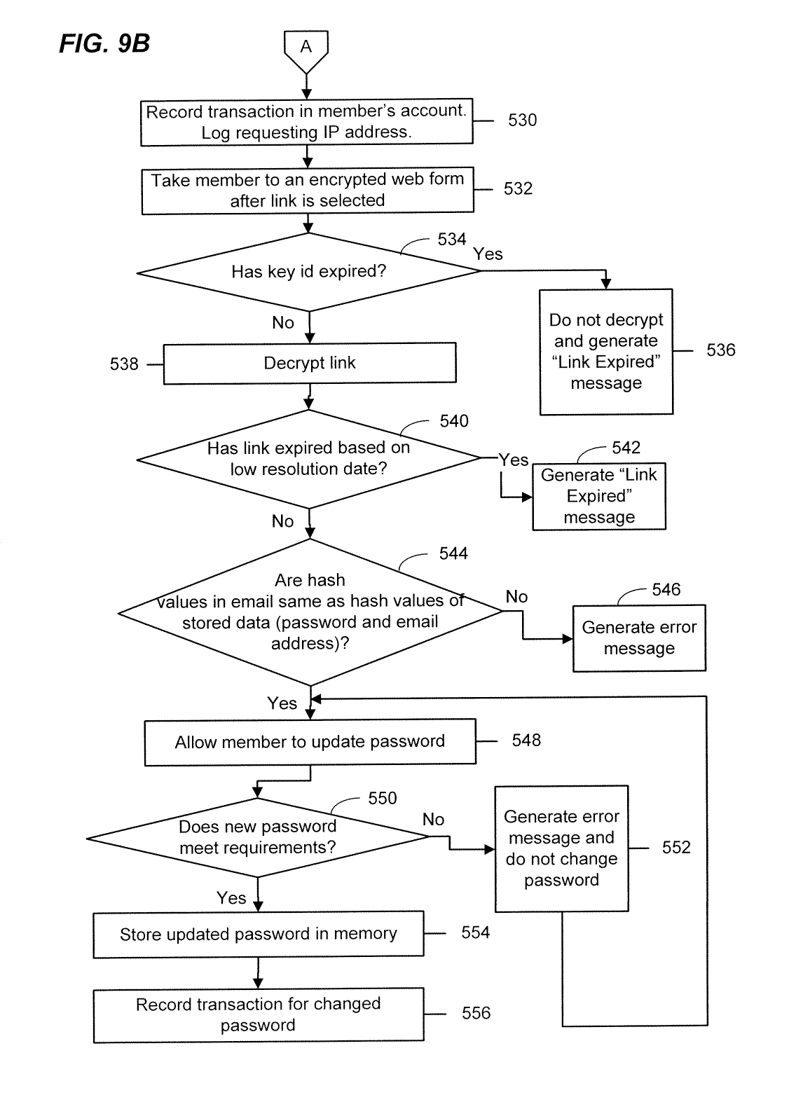

An exemplary method 500 of providing secure and efficient link expiration is illustrated in FIGS. 9A and 9B. The method 500 of FIGS. 9A and 9B may be utilized in conjunction with any of the exemplary system architectures disclosed in FIGS. 1-3, 5, 7, and 8, as well as any other similar architecture. The method 500 is disclosed hereafter with reference to the components shown in FIG. 7, however one of ordinary skill in the art will appreciate that the method 500 could be implemented using the components from the embodiments disclosed in FIGS. 1-3, 5, 8, or any other similar embodiments. As an overview, the method for providing secure and efficient link expiration includes ensuring that the e-mail link is available for only a limited amount of time, so that people other than the member who gain access to the member's e-mail will not be able to abuse access to the member's account. The security is provided by ensuring that the link is usable only once and ensuring that the link will eventually expire, even if it is never used.

Continuing with an overview, a member's current email address, to which a “forgot password” email is sent, and the member's previous password (or a hashed version of the previous password) are combined into a hashed value that is compared when the member clicks on a “forgot password” email link. If the member's email address or password have changed since the link was generated, the link is considered to be invalid because the hash of the member's current email address and current password will no longer match. This eliminates the need to store information on previous usage of “forgot password” email links altogether, as well as the need to look up such previous usage information.

Clicking on the link takes the member to a web form which is encrypted through the https protocol or other secure protocol where the member can securely enter a new password for their account. When the member uses the link to successfully create a new password, the account's password will have changed. Thus, clicking the link a second time results in a different hash value being computed from when the link was generated and the link is considered invalid for a second usage, unless the member happened to enter exactly the same password again.

Referring specifically to the exemplary method 500 illustrated in FIG. 9A, the method may begin after receiving data corresponding to a selection of a “forgot password” link (block 502). The method may then generate and display a web page form to obtain an e-mail address for the member (block 504). Those of ordinary skill in the art will appreciate that for enhanced security, additional personal information, such as, for example, the member's ZIP code may also be required to be entered into the web page form. If it is determined at the block 506 that personal information, such as the ZIP code, entered in the web form does not match the stored ZIP code associated with the member's account, an error message may be generated and displayed to the member (block 510).

If it is determined at the block 506 that the ZIP code from the web form matches the stored ZIP code, then a message may be displayed to the member indicating that an e-mail has been sent to the member's e-mail address that is stored in the member's account (block 512). The password, or a hash of the password (i.e., an encryption), stored for the member is then retrieved from a memory (block 514). An expiration date for the link may then be determined and a scaling factor may be applied to the expiration date to reduce the memory requirement for the expiration date (block 516). A key identifier for the expiration date with a reduced memory requirement (i.e., a low resolution date) may be included with the link (block 520). Applying the scaling factor may include determining an absolute time in seconds, minutes, hours, etc. and dividing that by a particular scaling number so that the expiration date may be represented with a value having a size that is only a couple of bytes, such as, for example, two bytes, as opposed to spinning a date map of whenever the link expires. This reduction in space allows for shorter links, which may be important in circumstances where the links may wrap inside of an e-mail if they are too long, which would cause the link to not work depending on the e-mail client. In other words, saving a few bytes in a link will make the link shorter and improve the chance of the link working without wrapping inside of a member's e-mail.

An encryption, for example, a hash, of the member's e-mail address and the password, as well as a unique member ID corresponding to the member and the key identifier may then be combined (block 522). The e-mail link may be generated and encrypted (block 524) and the key identifier may be placed in the first part of the link, where the key identifier identifies where the key is stored in a database. The method 500 may then include sending a reset password e-mail message to the member's e-mail address, with the reset password e-mail message including the link embedded therein (block 526).

As shown in FIG. 9B, the transaction may then be recorded in the member's account along with the requesting IP address (block 530). The member may then be taken to an encrypted web site after receiving data corresponding to selection of the embedded link by the member (block 532). The method 500 may then determine if the key identifier has expired (block 534). If it is determined at the block 534 that the key identifier has expired, the link will not be decrypted and a “link expired” message will be generated (block 536). If it is determined at the block 534 that the key identifier was not expired, the link will be decrypted (block 538). The system may then determine if the link has expired based on the low resolution date (block 540) and generate a “Link Expired” message (block 542).

If it is determined at the block 540 at the link has not expired, the method 500 may then determine if the link is valid (block 544). In other words, it is determined whether or not the link has been previously used. This may include determining if the hash values of the member's e-mail address and the member's password in the e-mail link are the same as the hash values for the member's e-mail address and the member's password stored in the member's account. If it is determined at the block 544 that the link is not valid, an error message is generated (block 546). If it is determined at the block 544 that the link is valid, the member is allowed to update the member's password (block 548).

The member may be required to enter a new password that meets a minimum number of requirements, such as, for example, a minimum length, a combination of alpha and numeric characters, and a second entry of the new password that matches the first entry of the new password (block 550). If it is determined at the block 550 that the new password does not meet the requirements, an error message may be generated and the password will not be updated (block 552). If however, it is determined at the block 550 that the updated password meets the minimum requirements, the updated password is then stored in memory (block 554). A record of the transaction for the updated password may also be stored in the member's account (block 556). Those of ordinary skill in the art will readily appreciate that the method 500 is readily applicable to any organization utilizing online accounts, such as, for example, online bank accounts, membership accounts, subscriptions, and so on.

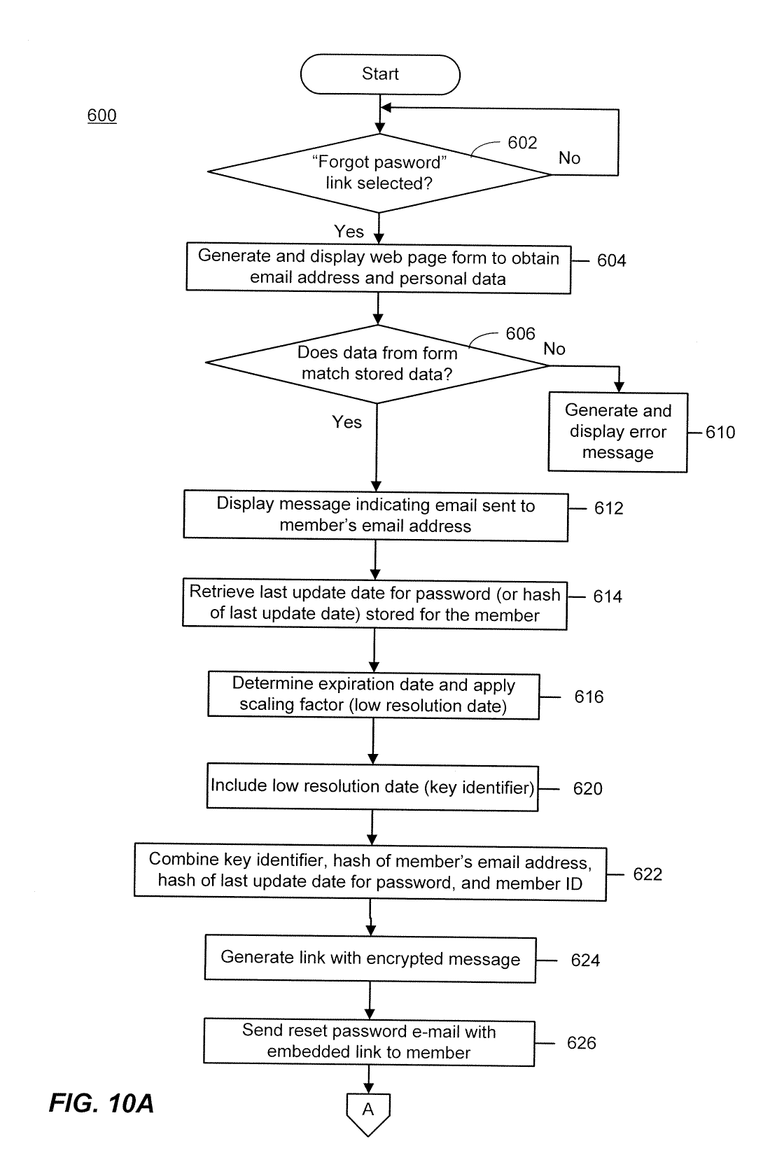

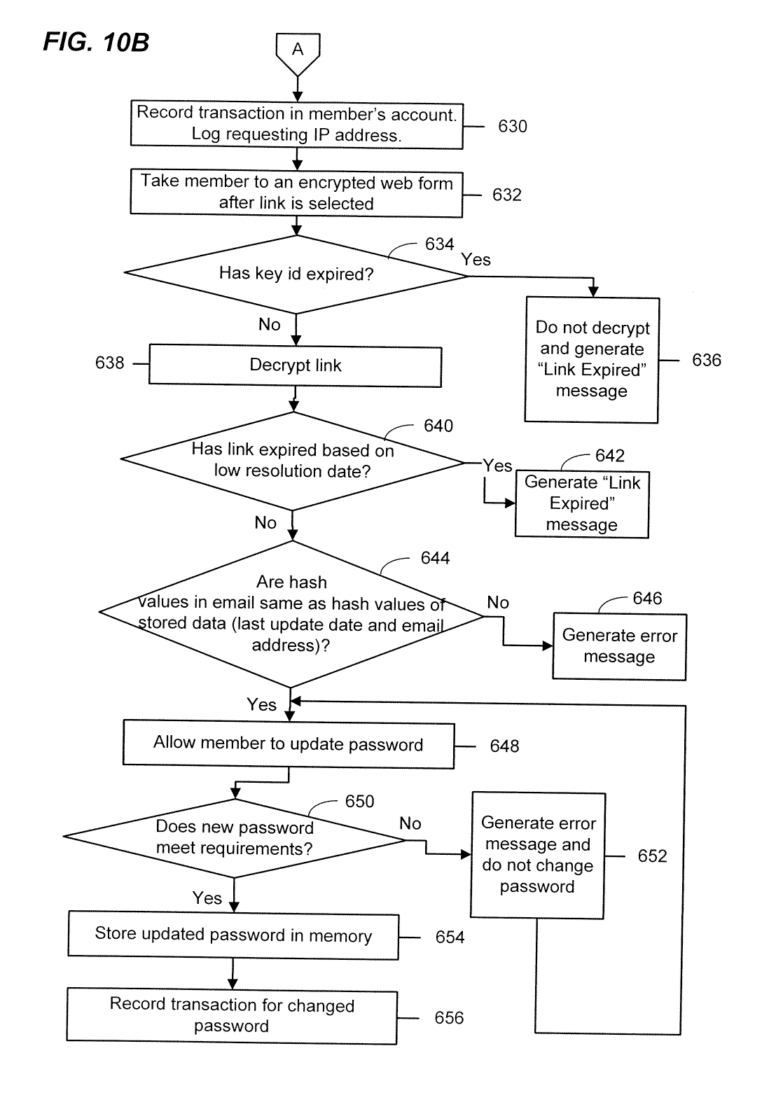

FIGS. 10A and 10B illustrate another exemplary embodiment of a method 600 for providing secure and efficient e-mail link expiration. The method 600 illustrated in the FIGS. 10A and 10B may begin after receiving data corresponding to a selection of a “forget password” link (block 602) wherein a web page form is then generated and displayed in order to obtain an e-mail address and possibly a set of personal data for the member (block 604). The method 600 may then determined whether the data entered in the web page form matches the data stored in the member's account (block 606). If it is determined that the data does not match, an error message is then generated and displayed (block 610).

If it is determined at the block 606 that the data from the Web form matches the stored data, a message indicating that an e-mail has been sent to the member's e-mail address to allow the member of change the member's password is then displayed (block 612). The last update date for the member's password, or a hash of the last update date, may then be retrieved from the member's account (block 614). The expiration date for the link is then determined and a scaling factor may be applied to allow for a low resolution representation of the expiration date (block 616). The low resolution representation of the expiration date, or a key identifier, is then included (block 620).

An encryption, for example, a hash, of the member's e-mail address and the last update date for the member's password, along with possibly a unique member ID corresponding to the member and the key identifier may then be combined (block 622). The link is then generated with the encrypted message (block 624). A reset password e-mail message is then sent to the member's e-mail address, with the reset password e-mail message including the link embedded therein (block 626).

The method 600 continues on FIG. 10B where the transaction is recorded in the member's account along with the requesting IP address (block 630). The member is then taken to an encrypted web site after receiving data corresponding to a selection of the embedded link by the member (block 632). If it is determined at the block 634 that the key identifier has expired, the link will not be decrypted and a “Link Expired” message may be generated (box 636). If it is determined at the block 634 that the key identifier has not expired, the link may be decrypted (block 640). After decrypting the link, the system may then determine if the link his expired based on the low resolution date (block 640). If it is determined that the link has expired at the block 640, a “Link Expired” message may then be generated (block 642).

If it is determined at the block 640 but the link has not expired, then the next step is to then determine whether or not the link is valid (block 644). This may include determining if the hash values of the member's e-mail address and the last update date of the member's password from the e-mail link are the same as the hash values for the member's e-mail address and the last update date members password stored in the member's account. If it is determined at the block 644 that the link is not valid, an error message may be generated (block 646). If it is determined at the block 644 that the link is valid, the member may be permitted to update the member's password (block 648). If the new password entered by the member does not meet a predefined set of requirements (block 650), an error message maybe generated and the password may not be changed (block 652). If it is determined at the block 650 that the new password meets requirements, the updated password is stored in memory (block 654) and a record of the transaction for the changed password is created in the member's account (block 656).

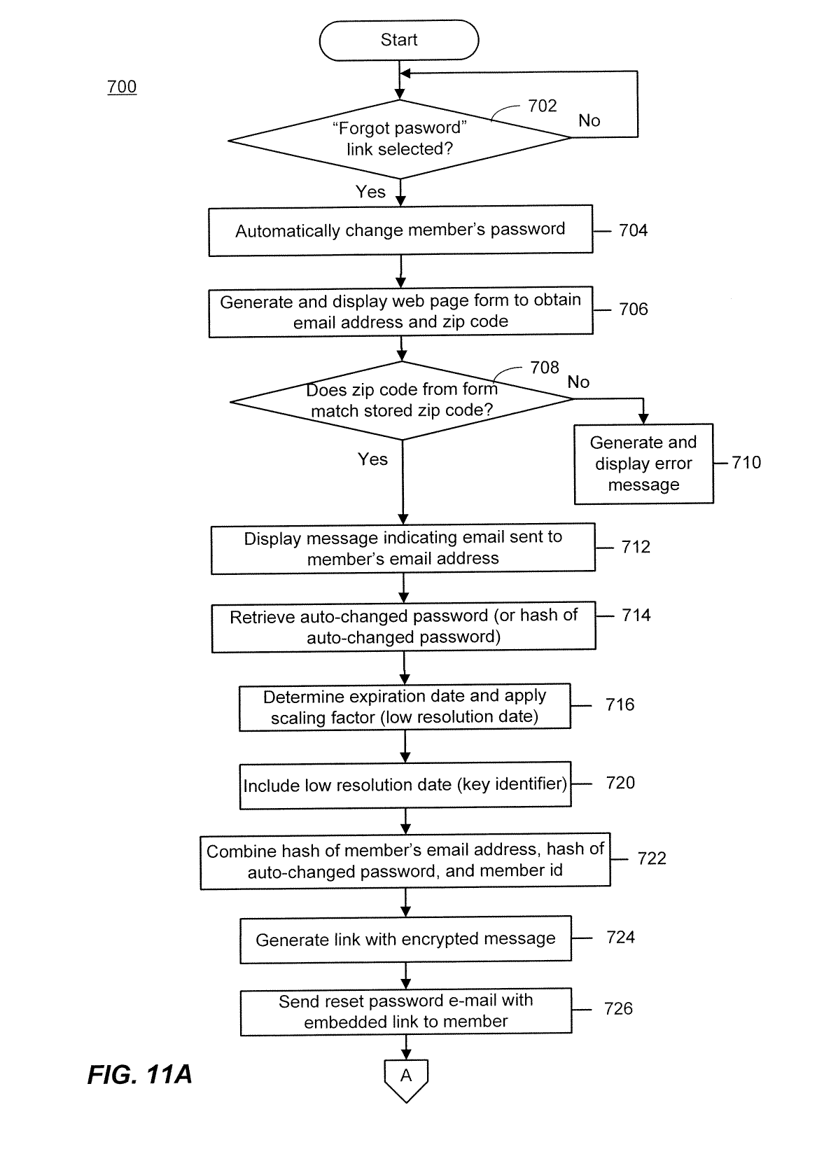

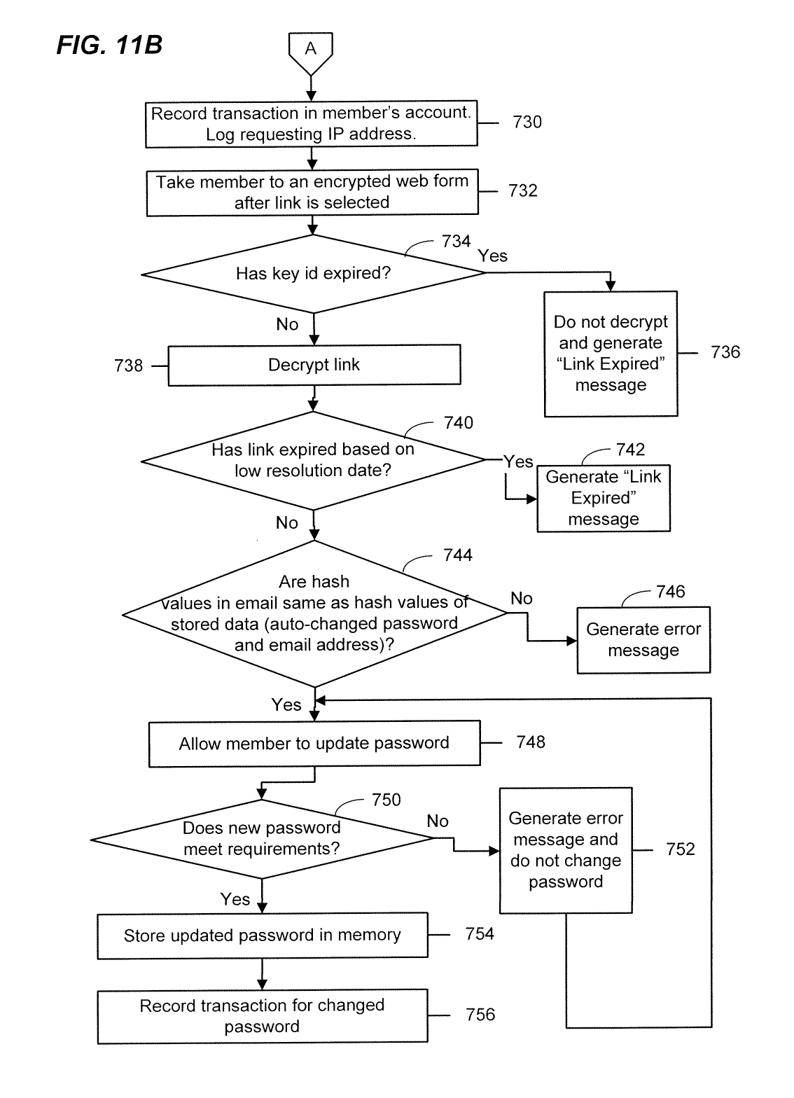

FIGS. 11A and 11B illustrate another exemplary flowchart showing several steps utilized in a method 700 for expiring links and ensuring one-time only use that includes automatically changing a member's password. The method 700 may begin after receiving data corresponding to a selection of a “Forgot Password” link (block 702). The method may then automatically change the members password (block 704). Thereafter, a web page form is generated and displayed to obtain an e-mail address and zip code or other personal information, for the member (block 706). Those of ordinary skill in the art appreciate that it is not necessary to obtain the personal information, however doing so provides additional security for the system.

If it is determined at the block 708 that the ZIP code or other personal information entered in the web page form does not match the stored ZIP code, or other personal information associated with the member's account, an error message may be generated and displayed to the member (block 710). If it is determined at the block 708 that the ZIP code or other personal information matches, then a message may be displayed to the member indicating that an e-mail has been sent to the member's e-mail address that is stored in the member's account (block 712).

The auto-changed password, or a hash of the auto-changed password, stored for the member is then retrieved from a memory (block 714). An expiration date for the link may then be determined and a scaling factor may be applied to the expiration date to reduce the memory requirement for the expiration date (block 716). The expiration date with the reduced memory requirement (i.e., a low resolution date) or a key identifier corresponding to the low resolution date, may be included with the link (block 720). An encryption, for example, a hash, of the member's e-mail address and the auto-changed password, as well as a unique member ID corresponding to the member, if used, may then be combined (block 722).

The e-mail link may be generated and encrypted (block 724) and the key identifier may be placed at the beginning of the link, where the key identifier identifies where the key is stored in a database. A reset password e-mail message is sent to the member's e-mail address, with a reset password e-mail message including the link embedded therein (block 726).

As shown in FIG. 11B, the transaction may then be recorded in the member's account along with the requesting IP address (block 730). The member may then be taken to an encrypted web site after receiving data corresponding to selection of the embedded link by the member (block 732). The method 700 may then determine if the key identifier has expired (block 734). If it is determined at the block 734 that the key identifier has expired, the link will not be decrypted and a “link expired” message will be generated (block 736). If it is determined at the block 734 that the key identifier has not expired, the link will be decrypted (block 738). After decrypting the link at block 738, the system may determine if the expiration date for the link has expired (block 740). If it is determined at the block 740 that the link has expired, a “Link Expired” message maybe generated (block 742).

If it is determined at the block 740 that the link has not expired, the method 700 may then determine if the link is valid (block 744). In other words, it is determined whether or not the link has been previously used. This may include determining if the hash values in the e-mail are the same as a hash values of the stored data. For example, the system may check to see if the hash values of the member's auto-changed e-mail address and the member's password from the link are the same as the hash values for the member's auto-changed e-mail address and the member's password stored in the member's account. If it is determined at the block 744 that the link is not valid, an error message is generated (block 746). If it is determined at the block 744 that the link is valid, the member is allowed to update the member's password (block 748).

The member may be required to enter a new password that meets a minimum number of requirements (block 750). If it is determined at the block 750 that the new password does not meet the requirements, an error message may be generated and the password will not be updated (block 752). If however, it is determined at the block 750 that the updated password meets the minimum requirements, the updated password is then stored in memory (block 754). A record of the transaction for the updated password may also be stored in the member's account (block 756).

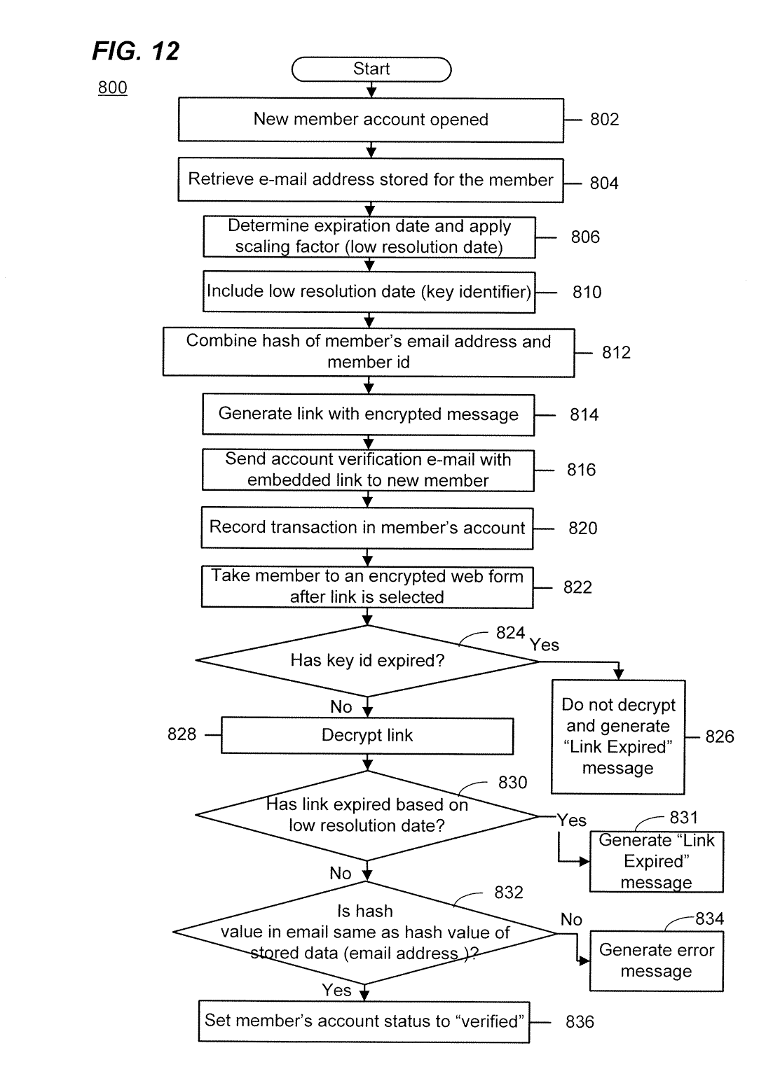

FIG. 12 illustrates an exemplary flowchart 800 showing several steps utilized in a method for expiring links and ensuring one-time only use when verifying a new member's account. The method 800 illustrated in FIG. 12 begins when a new member account is opened (block 802). An expiration date for the link is determined and a scaling factor is applied to the expiration date to reduce the memory requirement for the expiration date (block 806). This low resolution representation of the expiration date, or a key identifier corresponding to the low resolution date, is included with the link (block 810). After obtaining an e-mail address stored for the member (block 804), a hash of the member's e-mail address and a unique member ID corresponding to the member are combined (block 812). The link is then generated with an encrypted message (block 814).

An account verification e-mail with the embedded link is then sent to the new member (block 816). The transaction may be recorded in the member's account (block 820). The member is then taken to an encrypted web form after receiving data corresponding to a selection of the embedded link by the member (block 822). If it is determined at the block 824 that the key identifier has expired, the link will not be decrypted and a “Link Expired” message may be generated (block 826). If it is determined at the block 824 that the key identifier has not expired, the link may be decrypted (block 828) and a determination is made as to whether or not the link has expired (block 830). If it is determined at the block 830 that the link has expired, a “Link Expired” message maybe generated (block 831).

If it is determined at the block 830 that the link has not expired, the next step is to then determine whether or not the link is valid (block 832). This may include determining if the hash value of the member's e-mail address is the same as the hash values for the member's e-mail address stored in the member's account. If it is determined at the block 832 that the link is not valid, an error message may be generated (block 834). If it is determined at the block 832 that the link is valid, the member's account status is set to “verified” (block 836).

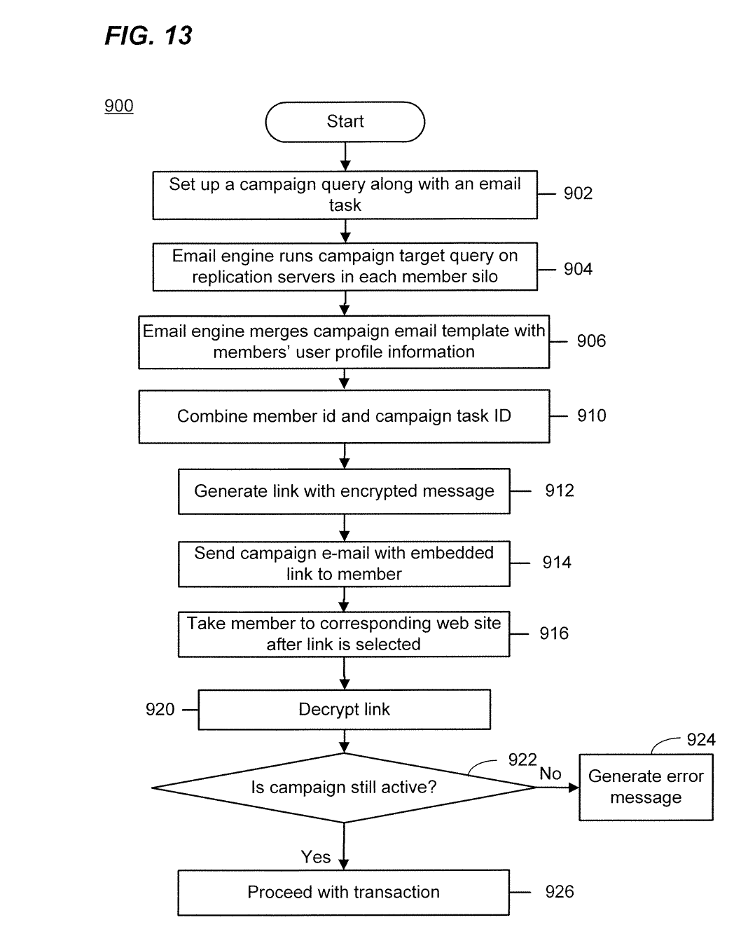

FIG. 13 illustrates an exemplary flowchart 900 showing several steps utilized in a method for expiring links when sending a campaign e-mail to an existing member. The method 900 illustrated in FIG. 13 begins when a campaign query and an e-mail task is set up (block 902). An e-mail engine 365 runs a campaign target query on the replication servers 370 in each member silo 360 in a group of servers 360 (block 904). The e-mail engine 365 mergers a campaign e-mail template with a plurality of members' user profile information (block 906), and a unique member ID corresponding to the member and possibly the campaign task ID are combined (block 910). The link is then generated with an encrypted message (block 912).

A campaign e-mail with the embedded link is then sent to the member (block 914). The member is taken to a corresponding web site after receiving data corresponding to a selection of the embedded link by the member (block 916). The link may then be decrypted (block 920).

The next step is to determine whether or not the campaign is still active (block 922). If it is determined at the block 922 that the campaign is no longer active, an error message may be generated (block 924). If it is determined at the block 922 that the campaign is still active, the system will then proceed with the transaction (block 926).

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A method for providing secure and efficient link expiration, comprising:
determining an email address for a member that a link is to be sent;
generating a link by combining an encryption of the member's email address and a unique member ID corresponding to the member;
determining an expiration date for the link;
applying a scaling factor to the expiration date to reduce the memory requirement for the expiration date;
including one of the expiration date with the reduced memory requirement or a key identifier corresponding to either the expiration date or the expiration date with the reduced memory requirement with the link;
sending an email message to the member's email address, with the email message including the link embedded therein;
taking the member to a web site after receiving data corresponding to selection of the embedded link by the member;
decrypting the link;
determining if the link has expired based on the expiration date with the reduced memory requirement; and
determining if the link is valid if the link has not expired.

2. The method of claim 1, further comprising determining if the key identifier has expired before decrypting the link and only decrypting the link if the key identifier has not expired.

3. The method of claim 1, wherein determining if the link is valid comprises determining if data in the email link corresponding to the member's email address is the same as data stored in the member's account corresponding to the member's email address.

4. The method of claim 1, wherein sending the email message with the embedded link comprises sending an account verification email to a new member, and further comprising setting the new member's account status to “verified” if the link is determined to be valid and not expired.

5. The method of claim 1, further comprising generating a web page form to obtain the member's email address and a zip code for the member after receiving data corresponding to selection of a “forgot password” link.

6. The method of claim 5, further comprising determining if is the zip code from the web page form matches the zip code stored in the member's account.

7. The method of claim 6, wherein generating the link comprises combining a hash of the member's email address, a hash of the member's password, the unique member ID corresponding to the member, and one of the key identifier or the expiration date with the reduced memory requirement.

8. The method of claim 7, wherein determining if the link is valid comprises determining if the hash values of the member's e-mail address and the member's password are the same as the hash values for the member's e-mail address and the member's password stored in the member's account.

9. The method of claim 8, further comprising allowing the member to update the password if it is determined that the link is valid and not expired.

10. The method of claim 1, wherein generating the link comprises combining a hash of the member's email address and a hash of the last update date of the member's password, and the unique member ID corresponding to the member, and determining if the link is valid by determining if the hash values of the member's e-mail address and the last update date of the member's password are the same as the hash values for the member's e-mail address and the last update date of the member's password stored in the member's account.

11. The method of claim 1, further comprising automatically changing the member's password after receiving data corresponding to selection of a “forgot password” link.

12. The method of claim 1, further comprising generating a web page form to obtain the member's email address and a zip code for the member after receiving data corresponding to selection of a “forgot password” link.

13. A method for providing secure and efficient link expiration, comprising:
generating a web page form to obtain a member's email address for the member after receiving data corresponding to a selection of a “forgot password” link;
displaying a message indicating that an e-mail has been sent to the member's e-mail address to allow the member to change the member's password;
determining an expiration date for the link;
applying a scaling factor to the expiration date to reduce the memory requirement for the expiration date;
generating the link by combining a hash of the member's email address, a hash of the member's password, a unique member ID corresponding to the member, and one of a key identifier corresponding to either the expiration date or the expiration date without reduced memory requirement, or the expiration date with the reduced memory requirement;
sending a reset password email message to the member's email address, with the reset password email message including the link embedded therein;
taking member to an encrypted web site after receiving data corresponding to selection of the embedded link by the member;
decrypting the link;
determining if the link has expired;
determining if the link is valid if it is determined that the link has not expired;
allowing the member to update the member's password if the link is determined to be valid and not expired; and
recording the transaction in the member's account.

14. The method of claim 13, wherein generating the web page form further comprises obtaining a set of personal data for the member after receiving data corresponding to selection of a “forgot password” link.

15. The method of claim 14, further comprising determining if is the set of personal data obtained from the web page form matches the set of personal data stored in the member's account.

16. The method of claim 13, wherein determining if the link is valid comprises determining if the hash values of the member's e-mail address and the member's password are the same as the hash values for the member's e-mail address and the member's password stored in the member's account.

17. The method of claim 16, further comprising automatically changing the member's password after receiving data corresponding to selection of the “forgot password” link.

18. A system for providing secure and efficient link expiration, comprising:
means for determining an email address for a member that a link is to be sent;
means for determining an expiration date for the link;
means for representing the expiration date in a low resolution format;
means for including with the link one of the expiration date in the low resolution format or a key identifier corresponding to either the expiration date or the expiration date in the low resolution format;
means for generating the link by combining: a hash of the member's email address, a unique member ID corresponding to the member, and one of the expiration date in the low resolution format or the key identifier corresponding to either the expiration date or the expiration date in the low resolution format;
means for sending an email message to the member's email address, with the email message including the link embedded therein;
means for taking the member to a web site after receiving data corresponding to selection of the embedded link by the member;
means for decrypting the link;
means for determining if the link has expired; and
determining if the link is valid if the link has not expired.

19. The system of claim 18, wherein the means for determining if the link is valid comprises a means for determining if data in the email link corresponding to the member's email address is the same as data stored in the member's account corresponding to the member's email address.

20. The system of claim 18, wherein the means for sending the email message with the embedded link comprises a means for sending an account verification email to a new member, and further comprising a means for setting the new member's account status to “verified” if the link is determined to be valid and not expired.

21. The system of claim 18, wherein the means for determining if the link has expired comprises a means for determining if the link has expired based on the expiration date in the low resolution format.

22. The system of claim 18, further comprising:
a means for generating a web page form to obtain the member's email address and personal information for the member after receiving data corresponding to selection of a “forgot password” link, and
a means for determining if is the personal information from the web page form matches the personal information stored in the member's account.

23. The system of claim 22, wherein the means for generating the link comprises a means for combining a hash of the member's email address, a hash of the member's password, and a unique member ID corresponding to the member.

24. The system of claim 23, wherein the means for determining if the link is valid comprises a means for determining if the hash values of the member's e-mail address and the member's password are the same as the hash values for the member's e-mail address and the member's password stored in the member's account.

25. The system of claim 23, further comprising a means for allowing the member to update the password if it is determined that the link is valid and not expired.

26. The system of claim 22, wherein the means for generating the link comprises a means for combining a hash of the member's email address, a hash of the last update date of the member's password, and the unique member ID corresponding to the member, and a means for determining if the hash values of the member's e-mail address and the last update date of the member's password are the same as the hash values for the member's e-mail address and the last update date of the member's password stored in the member's account.

27. The system of claim 22, further comprising a means for automatically changing the member's password after receiving data corresponding to selection of the “forgot password” link.

28. A system for providing secure and efficient link expiration, comprising:
a plurality of member server groups operatively coupled to a network, each of the plurality of member server groups comprising a first plurality of operatively coupled servers including an application server, a master data server and a plurality of replication data servers;
each of the plurality of member server groups including an e-mail engine, at least one of the e-mail engines configured to:
determine an email address for a member that a link is to be sent;
determine an expiration date for the link;
generate and encrypt a link that combines: a hash of the member's email address, a unique member ID corresponding to the member, and data associated with the expiration date;
send an email message to the member's email address, with the email message having the link embedded therein;
decrypt the link;
determine if the link has expired based on the data associated with the expiration date;
determine if the link is valid if it is determined that the link has not expired; and
an administrative server group operatively coupled to the network and to the plurality of member server groups, the administrative server group comprising a second plurality of operatively coupled servers including an application server, a master data server and a plurality of replication data servers.

29. The system of claim 28, wherein the at least one e-mail engine is further configured to determine if data in the email link corresponding to the member's email address is the same as data stored in the member's account corresponding to the member's email address.

30. The system of claim 28, wherein the at least one e-mail engine is further configured to send an account verification email to a new member and set the new member's account status to “verified” if the link is determined to be valid and not expired.

31. The system of claim 28, wherein the at least one e-mail engine is further configured to generate a web page form to obtain the member's email address and a zip code for the member after receiving data corresponding to selection of a “forgot password” link.

32. The system of claim 31, wherein the at least one e-mail engine is further configured to determine if is the zip code from the web page form matches the zip code stored in the member's account.

33. The system of claim 28, wherein the at least one e-mail engine is further configured to:
combine a hash of the member's email address, a hash of the member's password, and the unique member ID corresponding to the member;
determine if the hash values of the member's e-mail address and the member's password are the same as the hash values for the member's e-mail address and the member's password stored in the member's account; and
allow the member to update the password if it is determined that the link is valid and not expired.
